(19) United States
(12) Patent Application Publication
(10) Pub. No.: US 2008/0070561 A1
(43) Pub. Date: Mar. 20, 2008

(54) METHOD AND SYSTEM FOR REMOTELY MANAGING MOBILE TERMINAL

(75) Inventors: Ji-Eun Keum, Suwon-si (KR); Hae-Young Jun, Anyang-si (KR); Wuk Kim, Gwacheon-si (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/855,379

(22) Filed: Sep. 14, 2007

(30) Foreign Application Priority Data
Sep. 14, 2006 (KR) 10-2006-89363

(51) Int. Cl. H04M 3/00

(52) U.S. Cl. 455/419

(57) ABSTRACT

A method and system for remotely and wirelessly managing user settings of a mobile terminal for the functions and services by a device management server are provided. The method includes requesting a mobile terminal to transfer a configuration management object, which contains a node corresponding to a configuration parameter based on each setting condition changeable by the user in connection with various communication services and various functions provided by the mobile terminal, when the device management server has received a user-setting change request for the mobile terminal from an apparatus having management authority over the mobile terminal, receiving the configuration management object, to which a current user setting of the mobile terminal is applied, from the mobile terminal, and transmitting the received configuration management object to the apparatus having the management authority, and receiving a configuration parameter value determined by a user from the apparatus having the management authority, changing each node value of the configuration management object to the corresponding configuration parameter value, and transmitting the changed configuration management object to the mobile terminal, so that the mobile terminal changes and sets the configuration parameter according to each node value of the received configuration management object.

### PRIORITY

This application claims the benefit under 35 U.S.C. § 119(a) of a Korean patent application filed with the Korean Intellectual Property Office on Sep. 14, 2006 and assigned Serial No. 2006-89363, the entire disclosure of which is hereby incorporated by reference.

### BACKGROUND OF THE INVENTION

1. Field of the Invention

The present invention relates to management for a mobile terminal. More particularly, the present invention relates to a method and system for remotely and wirelessly managing user settings of a mobile terminal for functions and services by a device management server.

2. Description of the Related Art

User settings for functions of a mobile terminal or user settings for services provided through the mobile terminal are generally performed directly through the mobile terminal, but the settings for the user data stored in the mobile terminal may be changed through a personal computer. A user management system for such a mobile terminal may be configured as shown in FIG. 1.

FIG. 1 is a view illustrating a construction of a conventional user data management system for a mobile terminal.

Referring to FIG. 1, the user data management system for a mobile terminal includes a mobile terminal 30, a personal computer 10, and a cable 20 for connecting the mobile terminal 30 and the personal computer 10 to each other, in which user data can be synchronized through the cable 20. In this case, the personal computer 10 is equipped with an application program for mobile terminal management. That is, the personal computer 10 can download user data, such as a phonebook, a schedule, etc., stored in the mobile terminal 30 through the cable 20, or can upload user data stored in the personal computer 10 to the mobile terminal 30 by executing an application program for mobile terminal management. Accordingly, the user can manage user data of the mobile terminal 30 through the personal computer 10.

However, the management objects of the mobile terminal management system are limited to user data stored in the mobile terminal, and the mobile terminal management system does not support other user settings (e.g. functions for initial user settings or setting changes regarding a restriction in various communication functions, a display function, a sound function, etc.) relating to functions and services provided by the mobile terminal. Also, since the conventional mobile terminal management system connects the mobile terminal 30 and personal computer 10 to each other through the cable 20, it is not possible to remotely and/or wirelessly support a mobile terminal management service.

### SUMMARY OF THE INVENTION

An aspect of the present invention is to address at least the above-mentioned problems and/or disadvantages and to provide at least the advantages described below. Accordingly, an aspect of the present invention is to provide a method and system for managing a mobile terminal, which can change user settings relating to functions and services provided by the mobile terminal.

Another aspect of the present invention is to provide a method and system for managing a mobile terminal, which can remotely and wirelessly change user settings relating to functions and services provided by the mobile terminal.

In accordance with an aspect of the present invention, a method for remotely managing a mobile terminal is provided. The method comprises accessing, by an apparatus having management authority over the mobile terminal, a device management server, and transmitting a user-setting change request for the mobile terminal according to a user input or request, requesting, by the device management server, the mobile terminal to transfer a configuration management object, which contains a node corresponding to a configuration parameter based on each setting condition changeable by the user in connection with various communication services and various functions provided by the mobile terminal, transmitting, by the mobile terminal, the configuration management object, to which a current user setting is applied, to the device management server according to the request, transmitting, by the device management server, the configuration management object received from the mobile terminal, to the apparatus having the management authority, providing, by the apparatus having the management authority, the user with a configuration parameter represented by each node included in the configuration management object, setting each configuration parameter value according to a user input, and transmitting the configuration parameter value to the device management server, changing, by the device management server, each node value of the configuration management object to the corresponding configuration parameter value when the device management server has received the configuration parameter value, and transmitting the configuration management object to the mobile terminal, and setting, by the mobile terminal, each configuration parameter corresponding to each node according to each node value which is included in the configuration management object received from the device management server.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a view illustrating a construction of a conventional user data management system for a mobile terminal;

FIG. 2 is a block diagram illustrating a construction of a wireless remote management system for a mobile terminal according to an exemplary embodiment of the present invention;

FIG. 3 is a view illustrating a construction of nodes of a configuration management object (MO) according to an exemplary embodiment of the present invention;

FIG. 4 is a view illustrating an operation of a wireless remote management system based on an initial setting procedure of a mobile terminal according to an exemplary embodiment of the present invention; and

FIG. 5 is a view illustrating an operation of a wireless remote management system based on a setting change procedure of a mobile terminal according to an exemplary embodiment of the present invention.

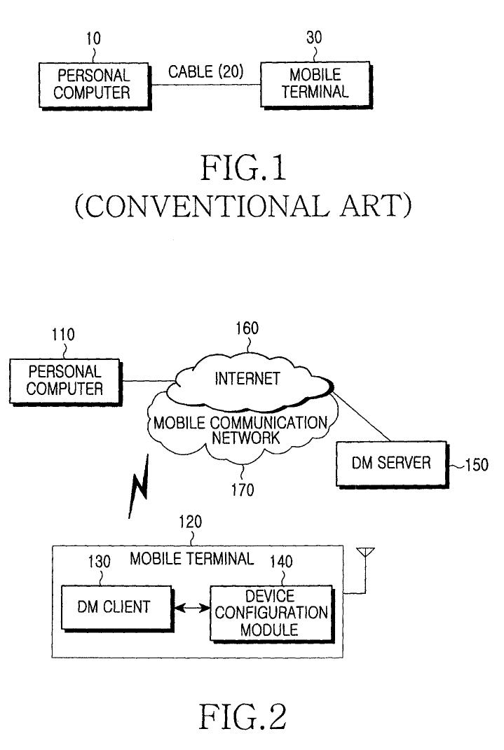

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and configurations will be omitted for clarity and conciseness.

A mobile terminal provides a user with various communication services, e.g., voice and video communication services, a messaging service, a wireless data service, etc., provided in a mobile communication system. The mobile terminal has a plurality of functions relating to various communication services and has various additional functions, such as a phonebook function, an alarm function, a game function, a music reproducing function, a schedule management function, etc., in addition to the communications function. The user can determine various user settings relating to communication services and various functions provided by the mobile terminal. That is, the user can establish whether or not each communication service is to be restricted and/or whether or not provision of each function is to be restricted. Also, the user can establish detailed conditions for each communication service and each function. For example, the user can establish settings about restrictions of originating/terminating calls for various types of communications and restrictions in access to user data, and can establish communication service-related specifications, such as a call forwarding service, an automatic response, a call termination/message arrival notifying scheme, and an incoming-call notification sound. Also, the user can establish detailed conditions for various additional functions, such as detailed display-related settings, detailed phonebook-related settings, an alarm setting, a schedule management, etc.

In the following description, each setting condition, which can be changed by the user, in association with various communication services and various functions provided by the mobile terminal, as described above, will be referred to as a “configuration parameter,” and information including one or more configuration parameter values will be referred to as “configuration information.” More particularly, parameters belonging to the same category can be defined by one node. That is, parameters may be classified into a display node, a sound node, etc. In addition, all settings, which can be changed by the user in connection with various communication services and various functions provided by the mobile terminal, will be referred to as “user settings.” The present invention is intended to remotely/wirelessly set and change the configuration parameter value, and the construction of a wireless remote management system according to an exemplary embodiment of the present invention is shown in FIG. 2.

FIG. 2 is a block diagram illustrating a construction of a wireless remote management system for a mobile terminal according to an exemplary embodiment of the present invention.

Referring to FIG. 2, a wireless remote management system for a mobile terminal includes a mobile terminal 120, a personal computer 110, the Internet 160, a mobile communication network 170, and a device management server (DM server) 150, which operate as follows. The user accesses the DM server 150 through the personal computer 110 or call service center, and requests an initial setting or a setting change for a configuration parameter of the mobile terminal 120. The DM server 150 configures a configuration management object (MO), which is defined in the format of an MO and is configuration information including a configuration parameter value, in response to the user request, and transmits the configuration MO to the mobile terminal 120. The mobile terminal 120 changes the configuration parameter value of the mobile terminal 120 according to the configuration MO received from the DM server 150. The detailed constructions of the configuration MO, the personal computer 110, and the DM server 150, which operates as described above, are as follows.

The mobile terminal 120 performs various mobile communication functions and includes a device management client (DM client) 130 and a device configuration module 140. The device configuration module 140 manages internal configuration parameters of a device, in which the device configuration module 140 provides the DM client 130 with profile information about a configuration parameter of the mobile terminal 120 in response to a device profile request of the DM client 130. In addition, the device configuration module 140 changes and sets each configuration parameter value to a corresponding node value of a configuration MO input from the DM client 130.

The DM client 130 communicates with the DM server 150 through a device management protocol, and transmits/receives MO defining information necessary for mobile terminal management to/from the DM server 150, thereby managing the mobile terminal 120. According to an exemplary embodiment of the present invention, when the DM client 130 receives a configuration MO request from the DM server 150 through the mobile communication network 170, the DM client 130 determines if there is a previously-generated configuration MO, and requests a device profile to the device configuration module 140 when there is no previously-generated configuration MO. Then, the DM client 130 generates a configuration MO, which defines a configuration parameter in the format of an MO, by using input profile information, stores a configuration parameter value corresponding to each node of the configuration MO in each node, and transmits the configuration MO to the DM server 150. If there is a previously-generated configuration MO, the DM client 130 transmits the configuration MO, to which a configuration parameter value of the mobile terminal 120 is currently applied, to the DM server 150. In addition, the DM client 130 analyzes a configuration MO received from the DM server 150, and outputs each node value of the configuration MO to the device configuration module 140.

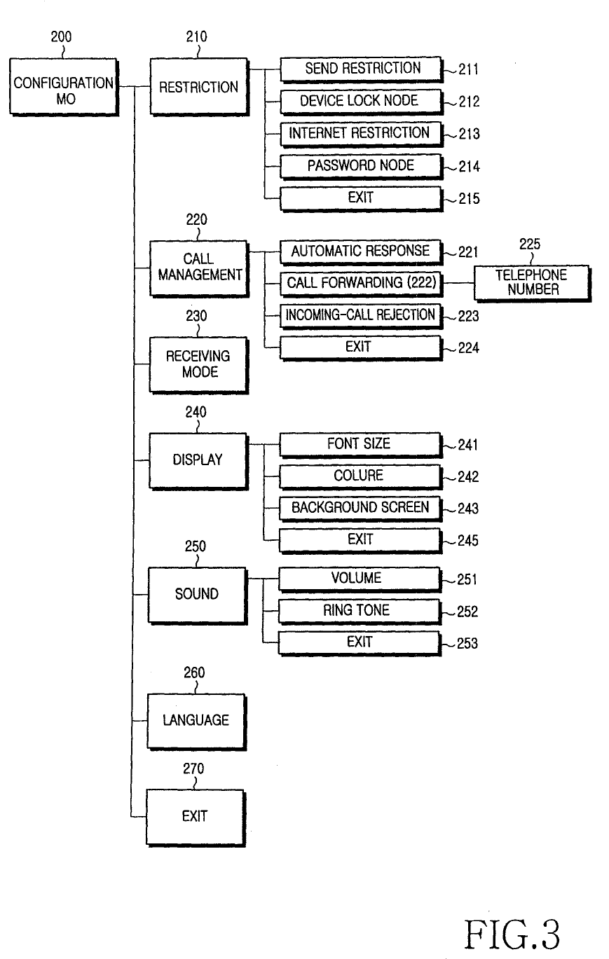

FIG. 3 is a view illustrating a construction of nodes of a configuration MO according to an exemplary embodiment of the present invention.

Referring to FIG. 3, configuration parameters of a mobile terminal, which a user wants to remotely change through the personal computer 110, may be reflected in the form of nodes of a configuration MO. An exit node is a node for extension, and indicates a node which can be used to add a node of a configuration MO according to addition of a configuration parameter of a mobile terminal. Since the value of each node must be changed in response to a user request, the DM server 150 has replacement authority for nodes. FIG. 3 illustrates an exemplary embodiment of the present invention, and may be extended to various forms of nodes.

A configuration MO node 200 includes a restriction (i.e., locking) node 210, a call management node 220, a receiving-mode node 230, a display node 240, a sound node 250, a language node 260 and an exit node 270.

The restriction node 210 includes a Send restriction node 211, a Device Lock node 212, an Internet restriction node 213, a password node 214 and an exit node 215, as lower nodes of the restriction node 210. Each of the Send restriction node 211, Device Lock node 212, and Internet restriction node 213 may have an enable/disable value for a function indicating each corresponding node, and the password node 214 stores a password value necessary for the restriction functions of the above nodes 211, 212 and 213.

The call management node 220 includes an automatic response node 221, a call forwarding node 222, an incoming-call rejection node 223 and an exit node 224, as lower nodes of the call management node 220. Each of the automatic response node 221, call forwarding node 222, and incoming-call rejection node 223 may have an enable/disable value for a function indicating each corresponding node. In addition, the call forwarding node 222 includes a telephone number node 225 as a lower node of the call forwarding node 222.

The telephone number node 225 has a telephone number, to which an incoming call is to be forwarded, set as a node value thereof. The receiving-mode node 230 indicates a termination notifying scheme according to communication, such as a call termination or message arrival, and may have one of ring/vibration/lamp as a node value thereof.

The display node 240 includes a font-size node 241, a color node 242, a background screen node 243 and an exit node 245, as lower nodes of the display node 240, in which each node 241, 242, 243 and 245 may have a node value within a range supported by the mobile terminal in relation to the function represented by each node.

The sound node 250 includes a volume node 251, a ring tone node 252 and an exit node 253, as lower nodes of the sound node 250, in which each of the volume node 251 and ring tone node 252 may have a value within a range supported by the mobile terminal.

The language node 260 may have values corresponding to languages supported by the mobile terminal.

The tree occurrence indicating on/off, formats, and access types of the nodes are shown in Table 1. In Table 1, “Replace” represents “writing,” and “Get” represents “reading.”

TABLE 1

| | Tree | | Min. |
|---|---|---|---|
| Node | Occurrence | Format | Access Type |
| Configuration MO node 200 | 1 | node | Get |
| Restriction (i.e., locking) node 210 | 1 | node | Get |
| Send restriction node 211 | 0 or 1 | chr | Replace |
| Device Lock node 212 | 0 or 1 | chr | Replace |
| Internet restriction node 213 | 0 or 1 | chr | Replace |
| Password node 214 | 0 or 1 | int | Replace |
| Exit node 215 | 0 or 1 | node | Get |
| Call management node 220 | 1 | node | Get |
| Automatic response node 221 | 0 or 1 | chr | Replace |
| Call forwarding node 222 | 0 or 1 | chr | Replace |
| Telephone number node 225 | 0 or 1 | int | Replace |
| Incoming-call rejection node 223 | 0 or 1 | chr | Replace |
| Exit node 224 | 0 or 1 | node | Get |
| Receiving-mode node 230 | 0 or 1 | chr | Replace |
| Display node 240 | 0 or 1 | node | Get |
| Font-size node 241 | 0 or 1 | int | Replace |
| Colure node 242 | 0 or 1 | chr | Replace |
| Background screen node 243 | 0 or 1 | chr | Replace |
| Exit node 245 | 0 or 1 | node | Get |
| Sound node 250 | 0 or 1 | node | Get |
| Volume node 251 | 0 or 1 | int | Replace |
| Ring tone node 252 | 0 or 1 | chr | Replace |
| Exit node 253 | 0 or 1 | node | Get |
| Language node 260 | 0 or 1 | chr | Replace |
| Exit node 270 | 0 or 1 | node | Get |

Referring again to FIG. 2, the personal computer 110 accesses the DM server 150 through the mobile communication network 170, performs an authentication procedure, and then transmits a user-setting change request for a mobile terminal to the DM server 150. In addition, the personal computer 110 receives a configuration MO relating to the mobile terminal 120 from the DM server 150, and provides the received configuration MO to the user. Thereafter, the personal computer 110 transmits each node value (i.e., each configuration parameter value) of the configuration MO corresponding to a user input to the DM server 150. Although an exemplary embodiment of the present invention is described about a case where the personal computer 110 is used as a means, other than the mobile terminal 120, for allowing the user to access the DM server 150, devices having a management authority, such as a user call center, may perform the same function as the personal computer 110.

According to an exemplary embodiment of the present invention, the DM server 150 requests a current configuration MO from the mobile terminal 120 in accordance with the request of the user who has accessed the DM server 150 through the Internet 160 by the personal computer 110, and then transmits a configuration MO of the mobile terminal 120, which has been transferred in response to the server's request, to the personal computer 110. Thereafter, when the DM server 150 receives each node value (i.e., each configuration parameter value) of the configuration MO, which has been requested by the user through the personal computer 110, the DM server 150 changes the configuration MO depending on the received value, and wirelessly transmits the changed configuration MO to the mobile terminal 120 through the Internet 160.

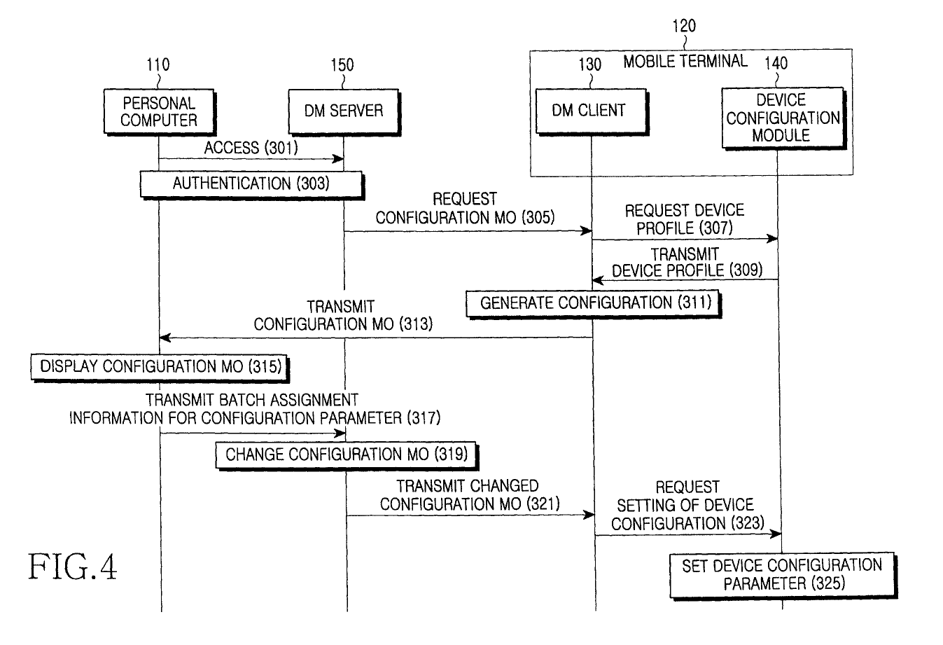

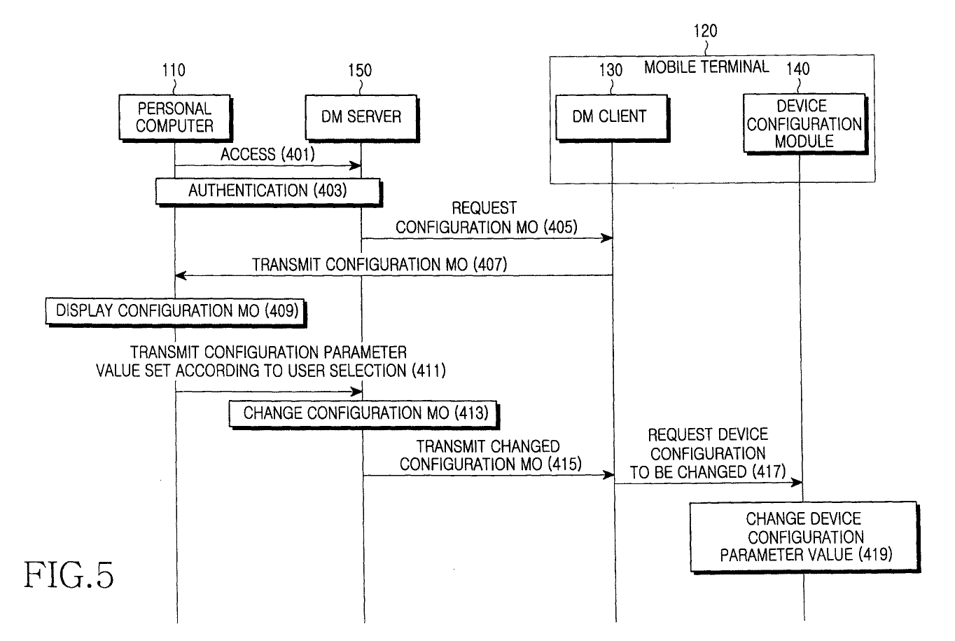

The operation of the wireless remote management system for a mobile terminal having the aforementioned construction according to an exemplary embodiment of the present invention will be described with reference to FIGS. 4 and 5.

FIG. 4 is a view illustrating an operation of a wireless remote management system based on an initial setting procedure of a mobile terminal according to an exemplary embodiment of the present invention, in which a case where various configuration parameters of a newly-purchased mobile terminal 120 are collectively set is shown.

Referring to FIG. 4, the user of the mobile terminal 120 requests access to the DM server 150 by the personal computer 110. The personal computer 110 accesses the DM server 150 according to the user request in step 301. Thereafter, in step 303, the personal computer 110 performs an authentication procedure by providing the DM server 150 with authentication information input by the user. When the authentication procedure is correctly performed, the personal computer 110 transmits a user-setting change request for the mobile terminal 120 according to a user input to the DM server 150. Accordingly, the DM server 150 requests a configuration MO to the mobile terminal 120 of the user through a device management protocol in step 305. When the DM client 130 of the mobile terminal 120 receives the configuration MO request from the DM server 150, the DM client 130 determines if there is a previously-generated configuration MO, and requests a device profile to the device configuration module 140 in step 307 when there is no previously-generated configuration MO. The device configuration module 140 transmits a device profile in step 309, including information about the configuration parameters of the mobile terminal 120, to the DM client 130 according to the device profile request. The DM client 130 generates a configuration MO including nodes corresponding to the configuration parameters of the mobile terminal 120 in step 311 by making reference to the received device profile, and transmits the generated configuration MO to the DM server 150 in step 313. The DM server 150 receives and transmits the configuration MO to the personal computer 110. The personal computer 110 receives and analyzes the configuration MO, and displays configuration parameters showing each node of the configuration MO in step 315. The user inputs values to set the displayed configuration parameters. When such a user input has been completed and a transmission request to the DM server 150 has been input, the personal computer 110 transmits batch assignment information for configuration parameters, including all configuration parameter values input by the user, to the DM server 150 in step 317. When the DM server 150 receives the batch assignment information for configuration parameters, the DM server 150 replaces each node value of the configuration MO, received from the mobile terminal 120 in step 313, with each corresponding parameter value included in the batch assignment information for configuration parameters, thereby changing the configuration MO in step 319. Thereafter, the DM server 150 transmits the changed configuration MO to the mobile terminal 120 through a DM protocol in step 321. In step 323, the DM client 130 of the mobile terminal 120 analyzes the configuration MO received in step 321, and transmits each node value of the configuration MO to the device configuration module 140 through a device configuration assignment request message, including each node value of the configuration MO. When the device configuration module 140 receives the device configuration assignment request, the device configuration module 140 sets device configuration parameters according to each corresponding node value included in the device configuration assignment request in step 325.

When a change in configuration parameters is required in the state in which the configuration parameters of the mobile terminal 120 have been set, there may be a case where the configuration parameters cannot be changed through the user interface of the mobile terminal 120 and the configuration parameters must be remotely changed according to the user's situation. For example, there may be a case where the user has lost the mobile terminal 120, a case where the user does not know where the mobile terminal 120 is located, a case where it is inconvenient for a handicapped user to use the user interface, or a case where the mobile terminal 120 has been set to display a language which the user cannot understand. The procedure of changing the configuration parameters of the mobile terminal 120 in such a case will be described with reference to FIG. 5.

FIG. 5 is a view illustrating an operation of a wireless remote management system based on a procedure of changing the settings of a mobile terminal according to an exemplary embodiment of the present invention.

Referring to FIG. 5, when a situation requiring the user to remotely change the user settings of the mobile terminal 120 occurs as described above, the user accesses the DM server 150 through the personal computer 110 in step 401. Thereafter, the personal computer 110 performs an authentication process with the DM server 150 by using authentication information input by the user in step 403. When authentication has been correctly completed, the personal computer 110 transmits a user-setting change request to the DM server 150, and the DM server 150 requests a configuration MO to the mobile terminal 120 according to such a user-setting change request in step 405. The DM client 130 of the mobile terminal 120 transmits a configuration MO, to which configuration parameter values currently set in the mobile terminal 120 are applied, to the DM server 150 in step 407. The DM server 150 receives and transmits the configuration MO to the personal computer 110. Then, the personal computer 110 analyzes the configuration MO, and displays configuration parameters represented by each node and currently set values thereof in step 409. The user selects a configuration parameter which the user wants to change among the displayed configuration parameters, and changes the value of the selected configuration parameter. The personal computer 110 transmits a configuration parameter value, which has been set according to the user selection, to the DM server 150 in step 411, and the DM server 150 changes the configuration MO according to the received configuration parameter value in step 413.

In an exemplary implementation, when a user has lost the mobile terminal 120, or when a user does not know where the mobile terminal 120 is, the user may set the mobile terminal 120 to execute an automatic response function or an incoming-call rejection function through the personal computer 110. Then, the DM server 150 changes the value of the automatic response node 221 or incoming-call rejection node 223 to an enable value, thereby activating the function desired by the user. Also, in order to prevent unapproved use of the mobile terminal 120, the user may make a setting to restrict the use of a communication function. Then, the DM server 150 activates a locking or restriction function or changes the value of the password node 214 by changing the values of the lower nodes of the restriction node 210, that is, the values of the Send restriction node 211, Device Lock node 212, Internet restriction node 213, and password node 214. In this case, by newly setting or changing the value of the password node according to a user request, the restriction function can be again released by a direct input through the mobile terminal 120 in the future. Also, the DM server and a DM protocol may be used in the same manner in order to restrict a corresponding function. Meanwhile, the user may request a change in a reception notifying scheme of the mobile terminal 120, or may request an automatic response function or an incoming-call rejection function to be set. Accordingly, the DM server 150 changes the value of the receiving-mode node 230 to a value corresponding to a reception notifying scheme set by the user, that is, to a value corresponding to one of vibration, lamp, and sound output schemes.

In another exemplary implementation, when it is inconvenient for a handicapped user to use a user interface, the user may adjust the volume of a ring through the personal computer 110, or may adjust the font size of characters to be displayed. Then, the DM server 150 adjusts the value of the volume node 251 or font size node 241. When the mobile terminal 120 has been set to display a language which the user cannot understand, the user may change the language set in the mobile terminal 120 though the personal computer 110. Then, the DM server 150 changes the value of the language node 260 according to a user input.

Thereafter, the DM server 150, which has changed the values of the nodes in the configuration MO according to the user selection, as described above, transmits the changed configuration MO to the mobile terminal 120 in step 415. The DM client 130 of the mobile terminal 120 receives and analyzes the configuration MO, and outputs each node value to the device configuration module 140, thereby requesting the device configuration parameter settings to be changed in step 417. The device configuration module 140 replaces the configuration parameter value corresponding to each node with each corresponding node value by making reference to received node values, thereby changing and setting the device configuration parameters in step 419.

As described above, according to exemplary embodiments of the present invention, when the user of the mobile terminal 120 is in a state in which the user cannot directly change the configuration information of the mobile terminal 120, the user can change the configuration parameter values of the mobile terminal 120 through the DM server 150. Accordingly, it is possible to protect personal information and personal data of the user, and it is possible to prevent unapproved use of the mobile terminal 120. Also, although the mobile terminal 120 is placed far away, it is possible to prevent an important call to be missed by setting the automatic response function or the call forwarding function. Also, by changing a receiving mode, it is possible to avoid acting rudely. As described above, the user can remotely change the user settings of the mobile terminal 120 by the configuration MO, so that it is possible to solve many inconveniences which may occur because the user does not hold the mobile terminal 120. In addition, although the user holds his/her own mobile terminal, the user can change the overall configuration information at one time by using his/her own PC, instead of using the inconvenient interface of the mobile terminal. Also, after the user stores various configuration templates according to user taste, the user can change the overall configuration information by selecting a desired template.

As described above, according to the present invention, when the user of a mobile terminal is in a state in which the user cannot directly change the configuration information of the mobile terminal, the user can change the configuration parameter values of the mobile terminal through the DM server. Accordingly, it is possible to protect personal information and personal data of the user, and it is possible to prevent unapproved use of the mobile terminal 120. Also, although the mobile terminal 120 is placed far away, it is possible to prevent an important call to be missed by setting the automatic response function or call forwarding function.

While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for remotely managing a mobile terminal, the method comprising:
accessing, by an apparatus having management authority over the mobile terminal, a device management server, and transmitting a user-setting change request for the mobile terminal according to at least one of a user input and a user request;
requesting, by the device management server, the mobile terminal to transfer a configuration management object, which contains at least one node corresponding to a configuration parameter based on each setting condition changeable by the user in connection with various communication services and various functions provided by the mobile terminal;
transmitting, by the mobile terminal, the configuration management object, to which a current user setting is applied, to the device management server according to the request;
transmitting, by the device management server, the configuration management object received from the mobile terminal, to the apparatus having the management authority;
providing, by the apparatus having the management authority, the user with a configuration parameter represented by each node included in the configuration management object, setting each configuration parameter value according to a user input, and transmitting the configuration parameter value to the device management server;
changing, by the device management server, each node value of the configuration management object to the corresponding configuration parameter value when the device management server has received the configuration parameter value, and transmitting the configuration management object to the mobile terminal; and
setting, by the mobile terminal, each configuration parameter corresponding to each node according to each node value which is included in the configuration management object received from the device management server.

2. The method as claimed in claim 1, wherein the transmitting, by the mobile terminal, of the configuration management object to the device management server comprises:
receiving the configuration management object request;
determining if there is a previously generated configuration management object;
collecting a profile for configuration parameters according to each setting condition changeable by the user in connection with various communication services and various functions provided by the mobile terminal when there is no previously generated configuration management object, and generating a configuration management object which includes nodes corresponding to the collected configuration parameters; and
transmitting the generated configuration management object to the device management server.

3. The method as claimed in claim 2, wherein the configuration management object comprises:
a configuration management object node which is a highest node; and
a restriction node, a call management node, a receiving-mode node, a display node, a sound node, a language node, and an exit node, which are lower nodes of the configuration management object node,
wherein the restriction node is used to set whether or not using each function and communication service of the mobile terminal is to be restricted, and comprises a Send restriction node, a Device Lock node, an Internet restriction node, a password node, and an exit node, as lower nodes of the restriction node, in which each node can have an enable/disable value for a function indicating each corresponding node, and the password node stores a password value necessary for release of the restriction functions by an input through the mobile terminal;
the call management node is used to set whether or not the communication service is to be executed, and comprises an automatic response node, a call forwarding node, an incoming-call rejection node, and an exit node, as lower nodes of the call management node, in which each node can have an enable/disable value for a function indicating each corresponding node, and a telephone number to which a call is to be forwarded is set as a node value in a telephone number node, which is a lower node of the call forwarding node;
the receiving-mode node is used to set a termination notifying scheme according to communication, and comprises at least one of a ring, a vibration and a lamp as a node value thereof;
the display node is used to set a display function of the mobile terminal, and comprises a font-size node, a color node, a background screen node, and an exit node, as lower nodes of the display node, in which each node can have a node value within a range supported by the mobile terminal in relation to each function represented by each node;
the sound node is used to set an output sound of the mobile terminal, comprises a volume node, a ring tone node, and an exit node, as lower nodes of the sound node, in which the volume node can have a value within a range supported by the mobile terminal; and
the language node can have values corresponding to languages supported by the mobile terminal.

4. A method for remotely managing a mobile terminal by a device management server, the method comprising:
requesting a mobile terminal to transfer a configuration management object, which contains a node corresponding to a configuration parameter based on each setting condition changeable by the user in connection with various communication services and various functions provided by the mobile terminal, when the device management server has received a user-setting change request for the mobile terminal from an apparatus having management authority over the mobile terminal;
receiving the configuration management object, to which a current user setting of the mobile terminal is applied, from the mobile terminal, and transmitting the received configuration management object to the apparatus having the management authority; and
receiving a configuration parameter value determined by a user from the apparatus having the management authority, changing each node value of the configuration management object to the corresponding configuration parameter value, and transmitting the changed configuration management object to the mobile terminal.

5. A method for remotely managing a mobile terminal, the method comprising:
receiving, from a device management server, a transmission request for a configuration management object, which contains a node corresponding to a configuration parameter based on each setting condition changeable by the user in connection with various communication services and various functions provided by the mobile terminal;
determining if there is a previously generated configuration management object;
collecting a profile for configuration parameters according to each setting condition changeable by the user in connection with various communication services and various functions provided by the mobile terminal when there is no previously generated configuration management object, and generating a configuration management object which includes nodes corresponding to the collected configuration parameters;
reflecting each currently set configuration parameter value in the previously generated configuration management object when the previously generated configuration management object exists;
transmitting the generated configuration management object to the device management server; and
setting a configuration parameter corresponding to each node according to each node value included in a certain configuration management object when the certain configuration management object has been received from the device management server.

6. A system for remotely managing a mobile terminal, the system comprising:
an apparatus, which has management authority over the mobile terminal, for accessing a device management server, for transmitting a user-setting change request for the mobile terminal to the device management server according to a user input, for providing the user with a configuration parameter represented by each node included in a configuration management object, which is received from the device management server and contains a node corresponding to the configuration parameter based on each setting condition changeable by the user in connection with various communication services and various functions provided by the mobile terminal, for setting each configuration parameter value according to a user input, and for transmitting the set configuration parameter value to the device management server;
the device management server for transmitting a configuration management object request to the mobile terminal when the device management server has received the user-setting change request, for transmitting the configuration management object received from the mobile terminal to the apparatus having the management authority, for changing the configuration parameter value corresponding to each node value of the configuration management object when the device management server has received the configuration parameter value from the apparatus having the management authority, and for transmitting the changed configuration management object to the mobile terminal; and
the mobile terminal for transmitting the configuration management object, to which a current user setting is applied, to the device management server when the mobile terminal has received the configuration management object request, and for setting a configuration parameter corresponding each node according to each node value included in the changed configuration management object received from the device management server.

7. A method for remotely managing a mobile terminal, the method comprising:
accessing a device management server by a first apparatus;
transmitting a change request for the mobile terminal according to a user input;
requesting the mobile terminal to transfer a configuration management object;
transmitting the configuration management object to the device management server;
transmitting the configuration management object to the first apparatus;
providing the user with information regarding at least one configuration parameter included in the configuration management object;
setting the at least one configuration parameter according to a user input;
transmitting the at least one configuration parameter to the device management server;
changing at least one value of the configuration management object according to the corresponding at least one configuration parameter;
transmitting the configuration management object to the mobile terminal; and
setting the mobile terminal to correspond to the at least one configuration parameter received.

8. The method as claimed in claim 7, wherein the configuration management object comprises a node corresponding to a configuration parameter based on each setting condition changeable by the user in connection with various communication services and various functions provided by the mobile terminal.
